(19) United States
(12) Patent Application Publication
(10) Pub. No.: US 2019/0307051 A1
(43) Pub. Date: Oct. 10, 2019

(54) Intelligent and Adjustable Boring and Separating Apparatus with A Cage Structure for Sandy Soil

(71) Applicant: Man Ho WONG, Hong Kong (HK)

(72) Inventor: Man Ho WONG, Hong Kong (HK)

(21) Appl. No.: 15/983,074

(22) Filed: May 17, 2018

(30) Foreign Application Priority Data
Apr. 8, 2018 (CN) 201810304496.X

(51) Int. Cl. A01B 39/08; A01B 39/28

(52) U.S. Cl. CPC A01B 39/085; A01B 39/28

(57) ABSTRACT

The invention relates to an intelligent and adjustable boring and separating apparatus with a cage structure for sandy soil which includes a position-adjusting mechanism, a control and power mechanism, and a boring and separating mechanism. The control and power mechanism includes a sleeve, a spacer, a steering control mechanism, a rotating mechanism, and an annular baffle. The steering control mechanism includes a first motor, a connecting rod, and a steering wheel. The rotating mechanism includes a sliding plate, a second motor, a gear and an inner ring. The boring and separating mechanism includes a shaft, a baffle plate, a reinforcement ring, and a fixing ring. The intelligent and adjustable boring and separating apparatus with a cage structure for sandy soil has advantages of having reasonable and simple structure, easy to operate, high intelligence, able to remove all kinds of sandy soil, time and labor saving, and high practicality, which effectively solves the problem of poor practicality of existing sieving machines.

### FIELD OF THE INVENTION

The invention relates to the field of agricultural machinery, in particular an intelligent and adjustable boring and separating apparatus with a cage structure for sandy soil.

### BACKGROUND

Sandy soil, as one of the basic categories of soil texture, refers to the soil with high content of sands among the soil particles. The soil has strong permeability, good ventilation, loose soil, and long tillage period. The soil is easy for farming, and easy for standing seedlings. However, sandy soil has a poor ability to retain water and nutrients, has a low nutrient content, and has a rapid change in soil temperature. Therefore, when growing crops on sandy soil, it is usually necessary to remove the larger sand to better preserve water and fertility.

With the continuous development of society, people's living standards have been improved, and more and more people are beginning to use mechanical screening to remove coarse sand from sandy soil. However, the sieving machines in the prior art only have screening functions and require manual or other machinery to transport the sand to the sieving machine for screening. The screened sand accumulates in the same place and requires manual or other machinery to backfill the screened sand back to its original location, which is troublesome. Further, the existing sieving machinery can only screen for the fixed radius sandstone, which is not practical.

### SUMMARY OF THE INVENTION

The technical problem to be solved is to overcome the above-mentioned deficiency by providing an intelligent and adjustable boring and separating apparatus with a cage structure for sandy soil. It has advantages of having reasonable and simple structure, easy to operate, high intelligence, able to remove all kinds of sandy soil, time and labor saving, and high practicality, which effectively solves the problem of poor practicality of existing sieving machines.

The technical solution of the present invention is to provide an intelligent and adjustable boring and separating apparatus with a cage structure for sandy soil which includes a position-adjusting mechanism with a frame structure, a control and power mechanism, and a boring and separating mechanism. The position-adjusting mechanism includes a connecting plate, a hydraulic cylinder hinged at the connecting plate.

The control and power mechanism includes a sleeve with a double-opening structure, a spacer fixedly disposed in one of the openings of the sleeve, a steering control mechanism, a rotating mechanism, an annular baffle disposed at another opening of the sleeve.

The steering control mechanism includes a first motor fixedly disposed at the spacer, a plurality of connecting rods, and a steering wheel. The steering wheel is in transmitting connection with the first motor. One end of the connecting rod is centered on the steering wheel and radially hinged at the steering wheel.

The rotating mechanism includes a circular sliding plate sleeved in the inner cavity of the sleeve, a second motor fixedly disposed on the sliding plate, a gear that is in transmitting connection with the second motor, and an inner ring fixedly disposed in the inner cavity of the sleeve. The inner ring is in transmitting connection with the gear. The inner cavity of the sleeve is provided with an inner convex ring. The sliding plate is slidably arranged between the inner convex ring and the annular baffle. The sliding plate is hinged with the hydraulic cylinder.

The boring and separating mechanism includes a shaft, a baffle plate, a reinforcement ring, and a fixing ring. A plurality of first through-holes are uniformly arranged on the bottom surface of the reinforcement ring in the circumferential direction. A plurality of second through-holes and boring teeth are uniformly arranged on the bottom surface of the fixing ring in the circumferential direction.

The shaft passes through the first through-holes, the second through-holes, and the sleeve in turn. The shaft extends into one end of the sleeve and is fixedly disposed with one end of a rotating plate. Another end of the rotating plate is hinged with a free end of the connecting rod. The shaft is provided with a slot along the central axis. One end of the baffle plate is clamped with the slot.

In a further embodiment, the connecting plate is provided with a connecting member. The connecting plate is connected with external construction machine via the connecting member.

In a further embodiment, balls are respectively arranged between the circular sliding plate and the inner wall of the sleeve, and between the inner convex ring and the annular baffle.

In a further embodiment, the boring teeth is a triangular pyramid structure. One of the edges is arranged in the tangential direction of the fixing ring at the position where it is located.

In a further embodiment, a rotary encoder is provided at the hinge point between the rotating plate and the connecting rod.

In a further embodiment, the shaft is threadedly connected with a plurality of limit rings used for defining the shaft and the baffle.

In a further embodiment, the boring teeth and the fixing ring are of a one-piece structure.

In a further embodiment, the baffle plate is provided with a magnetic stripe. The shaft is made of carbon structural steel. When the magnetic stripe and the adjacent shaft are close, they are attracted to each other.

In a further embodiment, the rotary encoder, the first motor, the second motor and the hydraulic cylinder are electrically connected with an external controller.

The technical effect of the invention is to provide an intelligent and adjustable boring and separating apparatus with a cage structure for sandy soil which includes a position-adjusting mechanism with a frame structure, a control and power mechanism, and a boring and separating mechanism. The boring and separating mechanism constitutes a cylindrical structure that can be opened and closed. The control and power mechanism controls the overall rotation of the boring and separating mechanism and the opening and closing angle of the baffle to remove the sandy soil with corresponding size. On the one hand, the position-adjusting mechanism is connected with the external machinery. On the other hand it controls the positions of the boring and separating mechanism and the control and power mechanism. During operation, the apparatus is mounted on an external machine such as an agricultural tractor. The functions of boring, loading, transporting and screening can be controlled by an external controller. The apparatus has advantages of having reasonable and simple structure, easy to operate, high intelligence, able to remove all kinds of sandy soil, time and labor saving, and high practicality, which effectively solves the problem of poor practicality of existing sieving machines.

### BRIEF DESCRIPTION OF THE DRAWINGS

The invention is illustrated by the following figures and embodiments.

FIG. 1 shows a schematic diagram of whole structure of an intelligent and adjustable boring and separating apparatus with a cage structure for sandy soil in accordance with an embodiment.

FIG. 2 shows a schematic diagram of a position-adjusting mechanism and a control and power mechanism of an intelligent and adjustable boring and separating apparatus with a cage structure for sandy soil in accordance with an embodiment.

FIG. 3 shows a schematic diagram of a steering control mechanism of an intelligent and adjustable boring and separating apparatus with a cage structure for sandy soil in accordance with an embodiment.

FIG. 4 shows a schematic diagram of the connection of a shaft, a baffle plate, an reinforcement ring, a fixing ring and a sleeve of an intelligent and adjustable boring and separating apparatus with a cage structure for sandy soil in accordance with an embodiment.

FIG. 5 shows a schematic diagram of the connection of a shaft and a baffle plate of an intelligent and adjustable boring and separating apparatus with a cage structure for sandy soil in accordance with an embodiment.

FIG. 6 shows a schematic diagram of a reinforcement ring of an intelligent and adjustable boring and separating apparatus with a cage structure for sandy soil in accordance with an embodiment.

FIG. 7 shows a schematic diagram of a fixing ring of an intelligent and adjustable boring and separating apparatus with a cage structure for sandy soil in accordance with an embodiment.

The reference numbers of the figures are as follows:
1: position-adjusting mechanism; 11: connecting plate; 12: hydraulic cylinder; 2: control and power mechanism; 21: sleeve; 211: inner convex ring; 22: spacer; 23: steering control mechanism; 231: first motor; 232: connecting rod; 233: steering wheel; 234: rotary encoder; 24: rotating mechanism; 241: sliding plate; 242: second motor; 243: gear; 244: inner ring; 25: annular baffle; 26: balls; 3: boring and separating mechanism; 31: shaft; 32: baffle plate; 33: reinforcement ring; 331: first through-cells; 34: fixing ring; 341: second through-cells; 342: boring teeth; 35: limit ring; 36: rotating plate; 37: slot; 38: magnetic stripe

### DETAILED DESCRIPTION

The invention is illustrated in accordance with figures. The figures as simplified diagrams demonstrate the basic structures of the apparatus of embodiments of the invention. Thus, the invention is not limited to the figures.

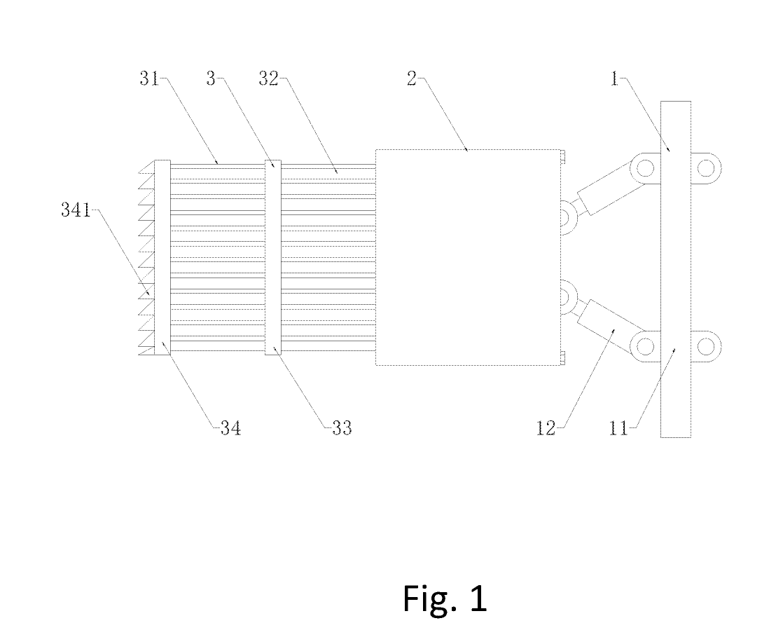

As shown in FIG. 1, an intelligent and adjustable boring and separating apparatus with a cage structure for sandy soil includes a position-adjusting mechanism 1 with a frame structure, a control and power mechanism 2, and a boring and separating mechanism 3. The position-adjusting mechanism 1 includes a connecting plate 11, a hydraulic cylinder 12 hinged at the connecting plate 11. In one embodiment, the hydraulic cylinder 12 can be replaced by an electric cylinder or a gas cylinder.

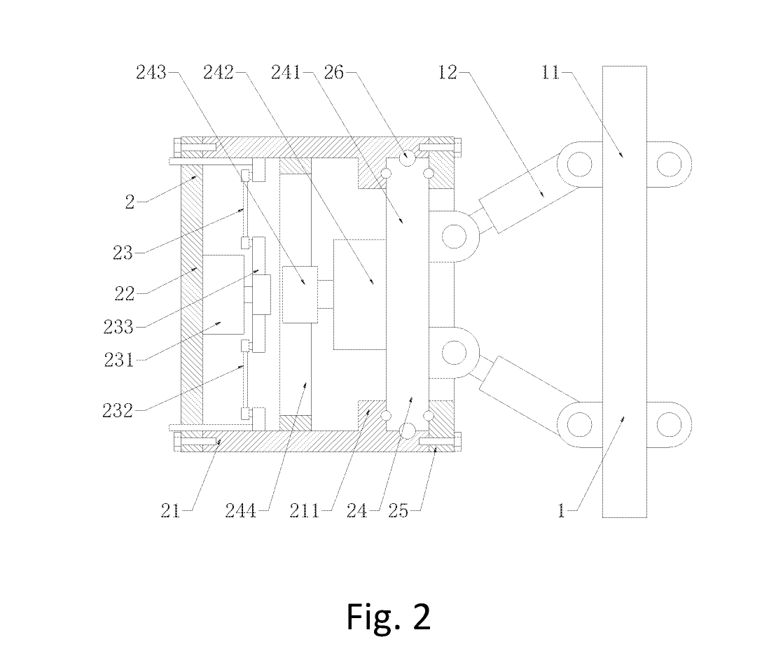

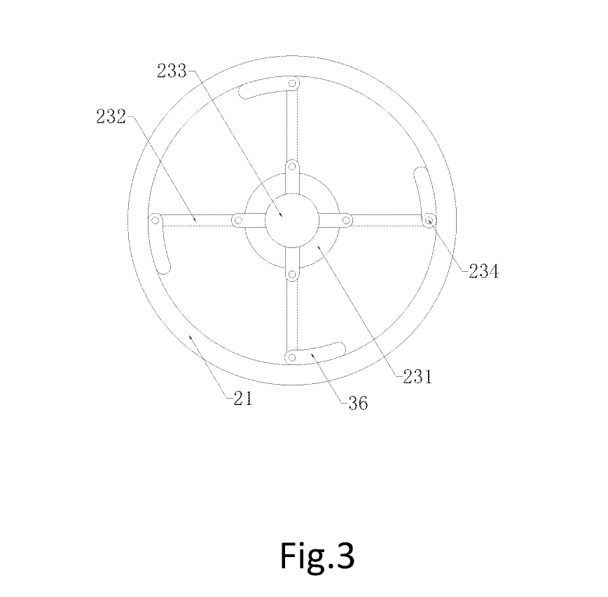

As shown in FIGS. 2 and 3, the control and power mechanism 2 includes a sleeve 21 with a double-opening structure, a spacer 22 fixedly disposed in one of the openings of the sleeve 21, a steering control mechanism 23, a rotating mechanism 24, an annular baffle 25 disposed at another opening of the sleeve 21.

The steering control mechanism 23 includes a first motor 231 fixedly disposed at the spacer 22, a plurality of connecting rods 232, and a steering wheel 233. The steering wheel 233 is in transmitting connection with the first motor 231. One end of the connecting rod 232 is centered on the steering wheel 233 and radially hinged at the steering wheel 233.

The rotating mechanism 24 includes a circular sliding plate 241 sleeved in the inner cavity of the sleeve 21, a second motor 242 fixedly disposed on the sliding plate 241, a gear 243 that is in transmitting connection with the second motor 242, and an inner ring 244 fixedly disposed in the inner cavity of the sleeve 21. The inner ring 244 is in transmitting connection with the gear 243. The inner cavity of the sleeve 21 is provided with an inner convex ring 211. The sliding plate 241 is slidably arranged between the inner convex ring 211 and the annular baffle 25. The hydraulic cylinder 12 passes through the annular baffle 25 and is hinged with the sliding plate 241.

As shown in FIGS. 1, 4, 5, 6 and 7, the boring and separating mechanism 3 includes a shaft 31, a baffle plate 32, a reinforcement ring 33, and a fixing ring 34. A plurality of first through-holes 331 are uniformly arranged on the bottom surface of the reinforcement ring 33 in the circumferential direction. A plurality of second through-holes 341 and boring teeth 342 are uniformly arranged on the bottom surface of the fixing ring in the circumferential direction.

The shaft 31 passes through the first through-holes 331, the second through-holes 341, and the sleeve 21 in turn. The shaft 31 extends into one end of the sleeve 21 and is fixedly disposed with one end of a rotating plate 36. Another end of the rotating plate 36 is hinged with a free end of the connecting rod 232. The shaft 31 is provided with a slot 37 along the central axis. One end of the baffle plate 32 is clamped with the slot 37.

In the embodiment as shown in FIGS. 1 and 2, the connecting plate 11 is provided with a connecting member. The connecting plate 11 is connected with external construction machine via the connecting member.

In the embodiment as shown in FIG. 2, balls 26 are respectively arranged between the circular sliding plate 241 and the inner wall of the sleeve 21, and between the inner convex ring 211 and the annular baffle 25. A groove is arranged on the circular sliding plate 241, the inner wall of the sleeve 21, the inner convex ring 211 and the annular baffle 25.

In the embodiment as shown in FIG. 7, the boring teeth 342 is a triangular pyramid structure. One of the edges is arranged in the tangential direction of the fixing ring 34 at the position where it is located. In one embodiment, the three surfaces of the boring teeth 342 are an arc structure other than the surface that connects to the fixing ring 34.

In the embodiment as shown in FIG. 3, a rotary encoder 234 is provided at the hinge point between the rotating plate 36 and the connecting rod 232. The rotary encoder 234 can also be replaced by an angle sensor or any element that can measure the angle change of the rotary shaft 31 in real time.

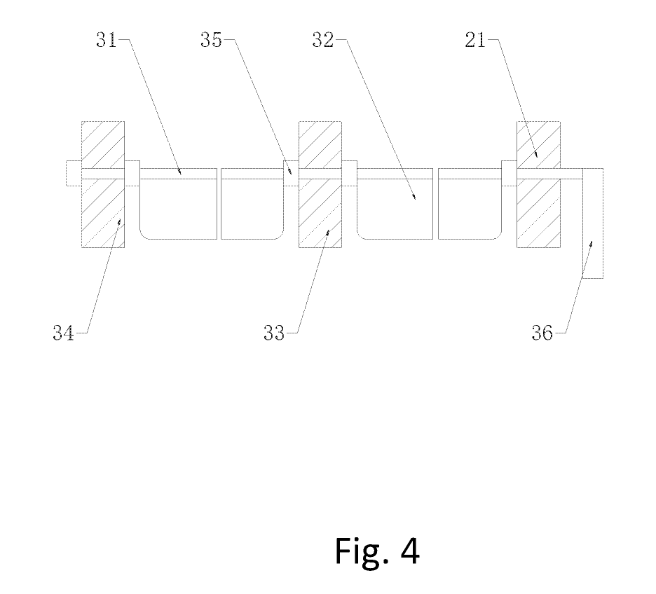

In the embodiment as shown in FIG. 4, the shaft 31 is threadedly connected with a plurality of limit rings 35 used for defining the shaft 31 and the baffle 32.

In the embodiment as shown in FIG. 7, the boring teeth 342 and the fixing ring 34 are of a one-piece structure.

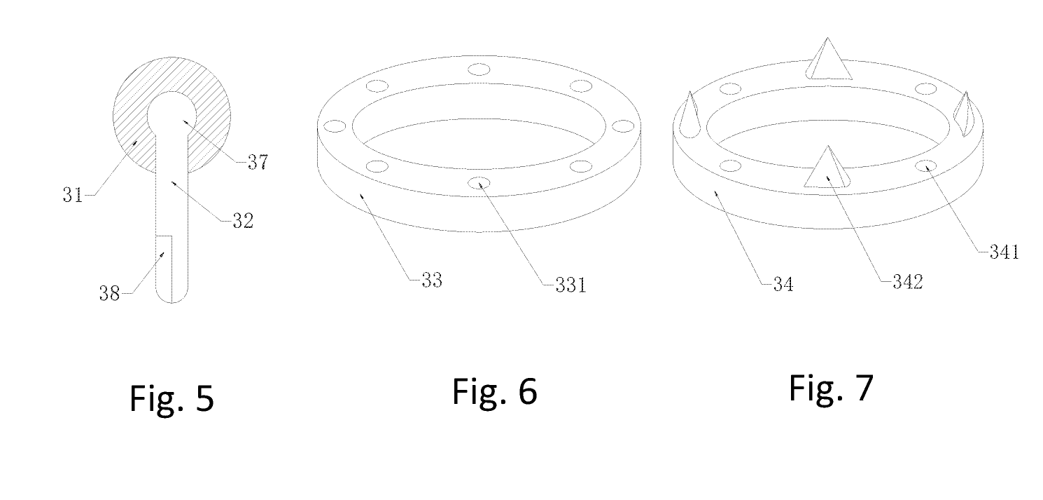

In the embodiment as shown in FIG. 5, the baffle plate 32 is provided with a magnetic stripe 38. The shaft 31 is made of carbon structural steel. When the magnetic stripe 38 and the adjacent shaft 31 are close, they are attracted to each other. In one embodiment, the shaft 31 is provided with an electromagnet that connects with an external controller.

In one embodiment, the rotary encoder 234, the first motor 231, the second motor 242 and the hydraulic cylinder 12 are electrically connected with an external controller. In another embodiment, the rotary encoder 234, the first motor 231, the second motor 242 and the hydraulic cylinder 12 are electrically connected with the controller disposed at any position. The controller communicates with the external control platform through a wired or wireless manner.

An intelligent and adjustable boring and separating apparatus with a cage structure for sandy soil of the invention includes a position-adjusting mechanism, a control and power mechanism, and a boring and separating mechanism. The boring and separating mechanism constitutes a cylindrical structure that can be opened and closed. The control and power mechanism controls the overall rotation of the boring and separating mechanism and the opening and closing angle of the baffle to remove the sandy soil with corresponding size. On the one hand, the position-adjusting mechanism is connected with the external machinery. On the other hand it controls the positions of the boring and separating mechanism and the control and power mechanism. During operation, the apparatus is mounted on an external machine such as an agricultural tractor. The functions of boring, loading, transporting and screening can be controlled by an external controller. The apparatus has advantages of having reasonable and simple structure, easy to operate, high intelligence, able to remove all kinds of sandy soil, time and labor saving, and high practicality, which effectively solves the problem of poor practicality of existing sieving machines.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. An intelligent and adjustable boring and separating apparatus with a cage structure for sandy soil, comprising: a position-adjusting mechanism 1 with a frame structure; a control and power mechanism 2; and a boring and separating mechanism 3, wherein the position-adjusting mechanism 1 includes a connecting plate 11, a hydraulic cylinder 12 hinged at the connecting plate 11;
wherein the control and power mechanism 2 includes a sleeve 21 with a double-opening structure, a spacer 22 fixedly disposed in one of the openings of the sleeve 21, a steering control mechanism 23, a rotating mechanism 24, and an annular baffle 25 disposed at another opening of the sleeve 21;
wherein the steering control mechanism 23 includes a first motor 231 fixedly disposed at the spacer 22, a plurality of connecting rods 232, and a steering wheel 233; the steering wheel 233 is in transmitting connection with the first motor 231; one end of the connecting rod 232 is centered on the steering wheel 233 and radially hinged at the steering wheel 233,
wherein the rotating mechanism 24 includes a circular sliding plate 241 sleeved in the inner cavity of the sleeve 21, a second motor 242 fixedly disposed on the sliding plate 241, a gear 243 that is in transmitting connection with the second motor 242, and an inner ring 244 fixedly disposed in the inner cavity of the sleeve 21; the inner ring 244 is in transmitting connection with the gear 243; the inner cavity of the sleeve 21 is provided with an inner convex ring 211; the sliding plate 241 is slidably arranged between the inner convex ring 211 and the annular baffle 25; the hydraulic cylinder 12 is hinged with the sliding plate 241,
wherein the boring and separating mechanism 3 includes a shaft 31, a baffle plate 32, a reinforcement ring 33, and a fixing ring 34; a plurality of first through-holes 331 are uniformly arranged on the bottom surface of the reinforcement ring 33 in the circumferential direction; a plurality of second through-holes 341 and boring teeth 342 are uniformly arranged on the bottom surface of the fixing ring in the circumferential direction,
wherein the shaft 31 passes through the first through-holes 331, the second through-holes 341, and the sleeve 21 in turn; the shaft 31 extends into one end of the sleeve 21 and is fixedly disposed with one end of a rotating plate 36; another end of the rotating plate 36 is hinged with a free end of the connecting rod 232; the shaft 31 is provided with a slot 37 along the central axis; one end of the baffle plate 32 is clamped with the slot 37.

2. The intelligent and adjustable boring and separating apparatus with a cage structure for sandy soil of claim 1, wherein the connecting plate 11 is provided with a connecting member; the connecting plate 11 is connected with external construction machine via the connecting member.

3. The intelligent and adjustable boring and separating apparatus with a cage structure for sandy soil of claim 1, wherein balls 26 are respectively arranged between the circular sliding plate 241 and the inner wall of the sleeve 21, and between the inner convex ring 211 and the annular baffle 25.

4. The intelligent and adjustable boring and separating apparatus with a cage structure for sandy soil of claim 1, wherein the boring teeth 342 is a triangular pyramid structure; one of the edges is arranged in the tangential direction of the fixing ring 34 at the position where it is located.

5. The intelligent and adjustable boring and separating apparatus with a cage structure for sandy soil of claim 1, wherein a rotary encoder 234 is provided at the hinge point between the rotating plate 36 and the connecting rod 232.

6. The intelligent and adjustable boring and separating apparatus with a cage structure for sandy soil of claim 1, wherein the shaft 31 is threadedly connected with a plurality of limit rings 35 used for defining the shaft 31 and the baffle 32.

7. The intelligent and adjustable boring and separating apparatus with a cage structure for sandy soil of claim 1, wherein the boring teeth 342 and the fixing ring 34 are of a one-piece structure.

8. The intelligent and adjustable boring and separating apparatus with a cage structure for sandy soil of claim 1, wherein the baffle plate 32 is provided with a magnetic stripe 38; the shaft 31 is made of carbon structural steel; when the magnetic stripe 38 and the adjacent shaft 31 are close, they are attracted to each other.

9. The intelligent and adjustable boring and separating apparatus with a cage structure for sandy soil of claim 1, wherein the rotary encoder 234, the first motor 231, the second motor 242 and the hydraulic cylinder 12 are electrically connected with an external controller.
